(19) United States
(12) Patent Application Publication
(10) Pub. No.: US 2025/0174737 A1
(43) Pub. Date: May 29, 2025

(54) SOLID ELECTROLYTE WITH MODIFIED LAYER AND PREPARATION METHOD THEREOF

(71) Applicants: CORNING INCORPORATED, CORNING, NY (US); SHANGHAI INSTITUTE OF CERAMICS, CHINESE ACADEMY OF SCIENCES, Shanghai (CN)

(72) Inventors: Michael Edward Badding, Campbell, NY (US); Huayan Huang, Shanghai (CN); Jun Jin, Shanghai (CN); Yan Lu, Shanghai (CN); Zhen Song, Painted Post, NY (US); Zhaoyin Wen, Shanghai (CN); Tongping Xiu, Shanghai (CN); Chujun Zheng, Huizhou City (CN)

(21) Appl. No.: 18/938,997

(22) Filed: Nov. 6, 2024

(30) Foreign Application Priority Data
Nov. 23, 2023 (CN) 202311569031.4

(51) Int. Cl. H01M 10/42; H01M 10/052; H01M 10/0562

(52) U.S. Cl. CPC H01M 10/4235; H01M 10/052; H01M 10/0562; H01M 2300/0094

(57) ABSTRACT

The disclosure relates to a solid electrolyte with a modified layer comprises: a solid electrolyte and a modified layer coated on the solid electrolyte. The solid electrolyte and the modified layer are connected by hydrogen bonds. The modified layer comprises an acid-treated carbon matrix and silver nanoparticles modified thereon. A method for preparing a solid electrolyte with a modified layer comprises: treating a carbon matrix with an acid, modifying silver nanoparticles on the acid-treated carbon matrix to obtain the silver nanoparticles modified on the acid-treated carbon matrix (Ag NPs@CNTs), mixing the Ag NPs@CNTs in suspension and coating them on a solid electrolyte, and drying and annealing the solid electrolyte to obtain the solid electrolyte with a modified layer.

### CROSS REFERENCE TO RELATED APPLICATION

This application claims the benefit of priority of Chinese Patent Application Serial No. 202311569031.4 filed on Nov. 23, 2023, the content of which is relied upon and incorporated herein by reference in its entirety.

### TECHNICAL FIELD

The invention relates to a solid electrolyte with a modified layer and a method for preparing it.

### BACKGROUND TECHNOLOGY

Lithium batteries are widely commercialized in portable electronic devices and electric vehicle applications. Lithium batteries have high energy density and safety. However, the performance of lithium batteries is often limited by the high interface resistance between the negative electrode and the solid electrolyte. The contact between lithium metal and the solid electrolyte is often insufficient, resulting in high interface resistance and the formation of lithium dendrites at the interface.

### SUMMARY

The present application discloses a solid electrolyte with a modified layer for lithium batteries and a method for preparing it.

An aspect of the present invention discloses a solid electrolyte with a modified layer, comprising: a solid electrolyte and a modified layer coated on the solid electrolyte, wherein the solid electrolyte and the modified layer are connected by hydrogen bonds, wherein the modified layer comprises an acid-treated carbon matrix and silver nanoparticles modified thereon.

Another aspect of the present invention discloses a lithium metal battery, comprising: a positive electrode, an electrolyte on the positive electrode, and a lithium negative electrode on the electrolyte, and the electrolyte is a solid electrolyte with a modified layer, comprising: a solid electrolyte and a modified layer coated on the solid electrolyte, wherein the solid electrolyte and the modified layer are connected by hydrogen bonds, in which the modified layer comprises a modified acid-treated carbon matrix and silver nanoparticles modified thereon.

In aspects that can be combined with any other aspect or embodiment, the thickness of the modified layer is in the range of 0.2-10 nm.

Among the aspects that can be combined with any other aspect or embodiment, the particle size of the silver nanoparticles is in the range of 2-20 nm.

In aspects that can be combined with any other aspect or embodiment, the weight ratio of silver nanoparticles in the modified layer is in the range of 30% to 50%.

In aspects that can be combined with any other aspect or embodiment, the carbon matrix comprises: carbon nanotubes (CNTs), carbon nanofibers (CNFs), graphene oxide (GO), three-dimensional (3D) carbon, or a combination thereof.

Among the aspects that can be combined with any other aspect or embodiment, the carbon matrix is a carbon nanotube with an aspect ratio in the range of 100 to 300.

In aspects that can be combined with any other aspect or embodiment, the porosity of the modified layer is in the range of 20% to 60%.

Among the aspects that can be combined with any other aspect or embodiment, the solid electrolyte comprises: Li₇La₃Zr₂O₁₂(LLZO), tantalum-doped garnet electrolyte (LLZTO), Li₁₀GeP₂S₁₂, Li_{1.5}Al_{0.5}Ge_{1.5}(PO₄)₃, Li_{1.4}Al_{0.4}Ti_{1.6}(PO₄)₃, Li_{0.55}La_{0.35}TiO₃ or a combination thereof.

Another aspect of the present invention discloses a method for preparing a solid electrolyte with a modified layer, comprising: treating a carbon matrix with an acid; modifying silver nanoparticles on the acid-treated carbon matrix to obtain the acid-treated carbon matrix and silver nanoparticles modified thereon (Ag NPs@CNTs), mixing Ag NPs@CNTs in suspension and coating them on a solid electrolyte; and drying and annealing the solid electrolyte to obtain the solid electrolyte with a modified layer.

In aspects that can be combined with any other aspect or embodiment, the weight percentage of Ag NPs@CNTs in suspension is in the range of 2% to 6%.

Among the aspects that can be combined with any other aspect or embodiment, the method further comprises that after treating a carbon matrix with an acid, the acid-treated carbon matrix is sensitized with a tin ion solution.

### DESCRIPTION OF THE DRAWINGS

The present disclosure will be made easier to be understood by combining the detailed description with the following drawings, in which:

FIGS. 1A-1G shows schematic and characterization diagrams of the preparation of the acid-treated carbon matrix and silver nanoparticles modified thereon in some embodiments. FIG. 1A is a schematic of the preparation of Ag NPs@CNTs powders, FIGS. 1B to ID are field emission scanning electron microscopy (FESEM) images, and FIGS. 1E to 1G are scanning electron microscopy (TEM) images, wherein FIGS. 1B and 1E characterize carbon nanotubes (CNTs),

FIGS. 1C and 1F characterize acid-treated CNTs, and FIGS. 1D and 1G characterize Ag NPs@CNTs powders.

FIGS. 2A-2B shows characterization diagrams of the material during the preparation of the acid-treated carbon matrix and silver nanoparticles modified thereon in some embodiments. FIG. 2A shows the X-ray diffraction spectrum (XRD) and FIG. 2B shows the thermogravimetric analysis of CNTs, acid-treated CNTs, and Ag NPs@CNTs powders, wherein a.u. represents any unit, i.e., the relative value of the data after normalization.

FIGS. 3A-3G shows schematic and characterization diagrams of the preparation process of a solid electrolyte with a modified layer in some embodiments. FIG. 3A is a schematic diagram of the preparation process of a solid electrolyte with a modified layer. FIGS. 3B, 3C, 3E, and 3F are field emission scanning electron microscopy (FESEM) images, FIGS. 3B and 3C correspond to LLZTO-AGC BA in FIG. 3A, i.e., the FESEM graph of Ag NPs@CNTs suspension applied to the surface of the solid electrolyte LLZTO after drying, FIGS. 3E and 3F correspond to the LLZTO-AGC of FIG. 3A, i.e., the FESEM graph of the solid electrolyte with a modified layer after annealing, and FIGS. 3D and 3G are the corresponding elemental mapping graphs of LLZTO-AGC BA and LLZTO-AGC, respectively.

FIG. 4 shows the interface features of LLZTO-AGC BA and LLZTO-AGC in some embodiments.

FIGS. 5A-5B is characterization diagrams of the materials in some embodiments. FIG. 5A shows the FTIR spectra of AGC, LLZTO and their mixing powders, and FIG. 5B shows the XRD graphs of LLZTO, LLZTO-AGC BA and LLZTO-AGC.

FIG. 6 shows cross-sectional FESEM images of Li/LLZTO (FIG. 6A) and Li/LLZTO-AGC (FIG. 6B) in some embodiments.

FIGS. 7A-7D shows the electrochemical evaluation of lithium-symmetrical batteries in some embodiments. FIG. 7A and FIG. 7B show the impedance curves, FIG. 7C shows the CCD measurement at the stepped current density, and FIG. 7D shows the cycling performance of the Li/LLZTO/Li and Li/AGC-LLZTO-AGC/Li symmetrical cells at different current densities at 25° C.

FIGS. 8A-8I shows the electrochemical performance of quasi-solid-state batteries in some embodiments. FIG. 8A is a schematic diagram of the NCM83 TMS/LLZTO-AGC/Li full cell, FIG. 8B shows the rate performance curve, FIG. 8C shows the charge-discharge curve at 0.1, 0.2, 0.5, 1, 2 and 0.1C, FIG. 8D is the impedance curve of the low-load NCM83 TMS/LLZTO-AGC/Li full cell, FIG. 8E is the cycling performance curve of the low-load full cell, FIG. 8F is the charge-discharge curve of the low-load full cell at 0.2C, FIG. 8G is the impedance curve of high-load NCM83 TMS/LLZTO-AGC/Li full cell, FIG. 8H is the cycling performance curve of the high-load full cell, and FIG. 81 is the charge-discharge curve of the high-load full cell at 0.5 mA cm⁻².

### DETAILED DESCRIPTION

Some exemplary embodiments of the present disclosure are described in detail below in conjunction with the accompanying drawings. Wherever possible, the same reference signs will be used in all drawings to refer to the same or similar meanings. The components in the drawings do not necessarily need to be drawn to scale, but focus on the principles of the illustrative embodiments given therein. It should be understood that the present application is not limited to details or methods set forth in the description or shown in the drawings. It should also be understood that the terms used in this disclosure are for descriptive purposes only and should not be considered restrictive.

In addition, any example set forth in the present application is illustrative, not restrictive, and only describes some of the many possible embodiments of the claimed invention. Some non-essential and other appropriate modifications and adjustments to various conditions and parameters commonly encountered in the art that are obvious to those skilled in the art are within the scope of protection of this disclosure.

Due to the rigidity characteristics of the solid-state electrolyte, its wettability with lithium is poor, and the contact is bad, resulting in large interface resistance, and uneven lithium-ion flux during cycling, and, the concentrated lithium-ion flow further leads to rapid penetration of dendrite along grain boundaries, which ultimately leads to a short life of garnet-based solid-state batteries. The present invention proposes to modify the surface of a solid electrolyte so as to solve the above problem.

Among the aspects that can be combined with any other aspect or embodiment, the solid electrolyte may include at least one of Li₇La₃Zr₂O₁₂(LLZO), tantalum-doped garnet electrolyte (LLZTO), Li₁₀GeP₂S₁₂, Li_{1.5}Al_{0.5}Ge_{1.5}(PO₄)₃, Li_{1.4}Al_{0.4}Ti_{1.6}(PO₄)₃ and Li_{0.55}La_{0.35}TiO₃, or a combination thereof. In some embodiments, the negative electrode may include lithium metal (Li). In some embodiments, the battery may include at least one anode protection measure, such as electrolyte additives (e.g., LiNO₃, lanthanum nitrate, copper acetate, P₂S₅, etc.), artificial interface layers (e.g., Li₃N, (CH₃); SiCl, Al₂O₃, LiAl, etc.), composite metals (e.g., Li₇B₆, Li-rGO (reduced graphene oxide), layered Li-rGO, etc., or a combination thereof.

In aspects that can be combined with any other aspect or embodiment, the positive electrode may include at least one of the lithium-based electrodes. The lithium-based electrode includes at least one of lithium cobalt oxide (LCO), lithium manganese spinel (LMO), lithium nickel-cobalt-aluminate (NCA), lithium nickel-nickel-manganese-cobalt oxide (NCM) (LiNi_{d}Co_{c}Mn_{1-d-e}O₂, where 0<d<1, and 0<e<1, e.g. LiNi_{0.5}CO_{0.2}Mn_{0.3}O₂ (NCM523), LiNi_{0.6}CO_{0.2}Mn_{0.2}O₂ (NCM622)), lithium iron phosphate (LiFePO₄) (LFP), lithium cobalt phosphate (LCP), lithium titanate, lithium niobium tungstate, lithium nickel manganeseate and lithium titanium sulfide (LiTiS₂).

The description and formation method of the solid electrolyte is described in the examples below.

### Example 1-Preparation of Ag NPs@CNTs Powder

First, the carbon nanotube (CNT) powder was acid-treated. A mixed acid of 25 ml of concentrated nitric acid and 75 ml of concentrated sulfuric acid was prepared. Then, 20 ml of 10 wt. % CNTs dispersion (purchased from XFNANO) was added to the mixed acid, heated and stirred for 1 h in a water bath at 70° C., where the aspect ratio of the CNTs was in the range of 100 to 300. The obtained solution was centrifuged at 5000 rpm for 3 mins to obtain acid-treated CNTs which were washed for four times with deionized water, and vacuum filtered with a large amount of deionized water until the filtrate was neutral. Acid-treated CNT powder was obtained by freeze-drying the obtained acid-treated CNTs for 24 hours.

Second, CNTs were sensitized by tin ion (Sn₂) solution. 0.3-0.12 g of SnCl₂·2H₂O was dissolved in 50 ml of 0.1 mol/L HCl, and then 0.25 g of acid-treated CNTs powder was added to the solution and sonicated for 45 min. The obtained solution was centrifuged at 5,000 rpm for 3 mins and washed for 3 times with deionized water to obtain Sn₂ sensitized CNTs. The prepared Sn₂ sensitized CNTs were dispersed in 10 ml of deionized water.

Third, silver ammonia solution was prepared. 0.5 g of silver nitrate was added to 40 ml of deionized water, then 0.2 ml of 0.1 mol per liter of sodium hydroxide was added with stirring, and then 2.5 ml of ammonia (containing 6.6% ammonia by weight) was added dropwise to the mixture to form a silver ammonia solution.

Finally, Ag NPs@CNTs powder was obtained. The pre-prepared Sn₂ sensitized CNTs dispersion was gradually added to the freshly prepared silver ammonia solution and stirred continuously for 1-5 h at room temperature. Next, the centrifugation was performed at 5000 rpm for 3 minutes to collect the produced Ag NPs@CNTs. Then, the product was washed for 3 times repeatedly with deionized water to ensure thorough removal of excess ions and unreacted substances. Finally, after 24 hours of freeze-drying, Ag NPs@CNTs powder was obtained. The particle size of silver nanoparticles in Ag NPs@CNTs powders analyzed by FESEM was in the range of 2-20 nm, and thermogravimetric analysis showed that the weight ratio of silver nanoparticles was in the range of 30% to 50%.

### Example 2-Preparation of LLZTO Solid Electrolyte

Li_{6.5}La₃Zr_{1.5}Ta_{0.5}O₁₂ (LLZTO) was synthesized by the traditional solid-phase method and sintered into ceramic particles. LiOH. H₂O (AR), La₂O₃(99.99%), ZrO₂ (AR) and Ta₂O₅ (99.99%) were mixed in stoichiometric ratios, and 10 wt. % of excess LiOH·H₂O was added for ball milling. The dried La₂O₃ powder was heated at 900° C. for 12 h. The powder mixture was calcined in an alumina crucible at 950° C. for 6 h to obtain a cubic phase LLZTO powder. The LLZTO powder was ball-milled at 250 rpm for 24 h to obtain a refined powder. The prepared LLZTO powder was then pressed into tablets in air in a platinum crucible and calcined at 1250° C. for 30 minutes. The LLZTO was polished and stored in an argon-filled glove box. The final LLZTO sheet is about 1.0 mm thick and 13.5 mm in diameter.

### Example 3-Preparation of Ag NPs@CNTs Modified LLZTO (LLZTO-AGC)

Ag NPs@CNTs modified LLZTO (LLZTO-AGC) was prepared by slurry coating technology. First, Ag NPs@CNTs powder and PVDF as a binder were stirred in N-methylpyrrolidone (NMP) at a weight ratio of 95:5 for 12 h, wherein the solid content was in the range of 2% to 6% by weight. Then, 15-50 μL of slurry was dropped onto the polished LLZTO surface and vacuum-dried at 70° C. for 12 h to further evaporate the solvent to obtain Ag NPs@CNTs modified LLZTO (LLZTO-AGC BA) prior to annealing. LLZTO-AGC was obtained by annealing the product at 600° C. for 2 h in Ar to remove PVDF and residual NMP. The FESEM analysis showed that the thickness of the modified layer was in the range of 0.2-10 nm, and Image J software measurements showed that the porosity of the modified layer was in the range of 20% to 60%.

### Example 4-Assembling a Symmetrical Lithium Battery

To prepare lithium/LLZTO/lithium or lithium/AGC-LLZTO-AGC/symmetrical lithium battery, the lithium anode was applied to both sides of the polished LLZTO or AGC-LLZTO-AGC by a melting method in an argon-filled glove box at 400° C. for 3 mins. All batteries were assembled in a CR2025 coin battery. In aspects that can be combined with any other aspect or embodiment, the heating was at 250° C. to 400° C., 275° C. to 375° C., 300° C. to 350° C. (e.g., 340° C.), 250° C. to 300° C., or 350° C. to 400° C., or any value or range disclosed therein. In any other aspect or embodiment that may be combined, the time was between 1 second and 20 minutes, 30 seconds to 15 minutes, 1 minute to 10 minutes, 3 minutes to 10 minutes, or 5 minutes to 10 minutes, or any value or range disclosed therein.

### Example 5-Assembling a Low-Load Quasi-Solid-State Full Cell

To prepare a low-load NCM83 TMS/LLZTO-AGC/Li full cell, a lithium anode was applied to the surface of LLZTO-AGC by a melting method in an argon-filled glove box at 400° C. for 3 minutes with a mass load of 3-4 mg cm⁻² of LiNi_{0.83}CO_{0.12}Mn_{0.05}O₂ (NCM83). The full cell was wetted with 15 μL of tetramethylene sulfone (TMS) solution containing 1.2 mol per liter of lithium bisfluorosulfonimide (LiFSI) at the cathode/LLZTO-AGC interface. All cells were assembled in a CR2025 coin battery.

### Example 6-Assembling a High-Load Quasi-Solid-State Full Cell

To prepare a high-load NCM83 TMS/LLZTO-AGC/Li full cell, a lithium anode is applied to the surface of LLZTO-AGC by a melting method in an argon-filled glove box at 400° C. for 3 mins. The mass load of LiNi_{0.83}CO_{0.12}Mn_{0.05}O₂ (NCM83) was 17-17.5 mg cm⁻². The full cell was wetted with 20 μL of tetramethylene sulfone (TMS) solution containing 1.2 mol per liter of lithium bisfluorosulfonimide (LiFSI) at the cathode/LLZTO-AGC interface. All cells were assembled in a CR2025 coin battery.

### Example 7-Characterization Study

### Morphology and Phase Analysis

FESEM images were acquired by field emission scanning electron microscopy (FESEM, Hitachi S-3400 N, and Magellan 400) and surface elemental composition was detected by coupled energy dispersive X-ray spectroscopy (EDS). TEM images were acquired by transmission electron microscopy (TEM, JEOL JEM-2100F). X-ray diffraction (XRD) by Cu K a radiation ( )=1.542 Å) using Rigaku Ultima IV to determine the phase of the sample. Thermogravimetric analysis (NETZSCH, STA 409PC) was performed to investigate the weight ratio of Ag nanoparticles in Ag NPs@CNTs.

### Electrochemical Properties

Electrochemical impedance spectroscopy (EIS) was measured by AC impedance analysis (Autolab, model PGSTAT302 N) in the frequency range of 0.1 Hz-1 MHz. All Li symmetrical cells and full cells were tested on a Neware battery test system (NEWARE CT-4008, Shenzhen, China). A rate cycle test of the Li symmetrical battery was performed at the initial current density of 0.1 mA·cm⁻². The critical current density of LLZTO and LLZTO-AGC was determined at an increment of 0.1 mA·cm⁻². The charging and discharging time was set to 30 minutes. For full cells, in the voltage range of 2.8-4.3 V, they were tested with a constant current cycle of 0.14 mA·cm−2 or 0.5 mA·cm⁻².

### Example 8-Sample Preparation

### Sample 1:

Ag NPs@CNTs powder and PVDF were mixed in N-methylpyrrolidone (NMP) at a weight ratio of 95:5 and stirred for 12 h. The solid content was 4.5 wt. %. 15 μl of slurry was dropped onto the polished LLZTO surface and vacuum-dried at 70° C. for 12 h to further evaporate the solvent. LLZTO-AGC was obtained by removing PVDF and residual NMP through annealing at 600° C. in argon for 2 h. To make a Li/AGC-LLZTO-AGC/Li symmetrical battery, a lithium anode was applied to both sides of the AGC-LLZTO-AGC by a melting method in an argon-filled glove box at 400° C. All batteries were assembled in a CR2025 coin battery.

### Sample 2:

Ag NPs@CNTs powder and PVDF were mixed in N-methylpyrrolidone (NMP) at a weight ratio of 95:5 and stirred for 12 h. The solid content was 4.5 wt. %. 15 μ 1 of slurry was dropped onto the polished LLZTO surface and vacuum-dried at 70° C. for 12 h to further evaporate the solvent. LLZTO-AGC was obtained by removing PVDF and residual NMP through annealing at 600° C. in argon for 2 h. To make a low-load NCM83 TMS/LLZTO-AGC/Li full cell, a lithium anode was applied to the surface of LLZTO-AGC by the melting method in an argon-filled glove box at 400° C. The mass load of LiNi_{0.83}CO_{0.12}Mn_{0.05}O₂ (NCM83) was 3-4 mg cm⁻². The full cell was wetted with 15 μl of TMS containing 1.2 mol per liter of LiFSI at the cathode/LLZTO-AGC interface. All cells were assembled in a CR2025 coin battery.

### Sample 3:

Ag NPs@CNTs powder and PVDF were mixed in N-methylpyrrolidone (NMP) at a weight ratio of 95:5 and stirred for 12 h. The solid content was 4.5 wt. %. 15 μl of slurry was dropped onto the polished LLZTO surface and vacuum dried at 70° C. for 12 h to further evaporate the solvent. LLZTO-AGC was obtained by removing PVDF and residual NMP through annealing at 600° C. in argon for 2 h. To make a high-load NCM83 TMS/LLZTO-AGC/Li full cell, a lithium anode was applied to the surface of LLZTO-AGC by the melting method in an argon-filled glove box at 400° C. The mass load of LiNi_{0.83}CO_{0.12}Mn_{0.05}O₂ (NCM83) was 17-17.5 mg cm⁻². The whole cell was wetted at the cathode/LLZTO-AGC interface with 20 μl of TMS containing 1.2 mol per liter of LiFSI. All cells were assembled in a CR2025 coin battery.

### Comparative Sample 1:

The prepared LLZTO was only polished. In a glove box filled with argon, both sides of the unmodified (only polished) LLZTO were coated with lithium anode for 3 minutes by the melting method at 400° C. A symmetrical lithium battery was assembled in 2025 type coin battery.

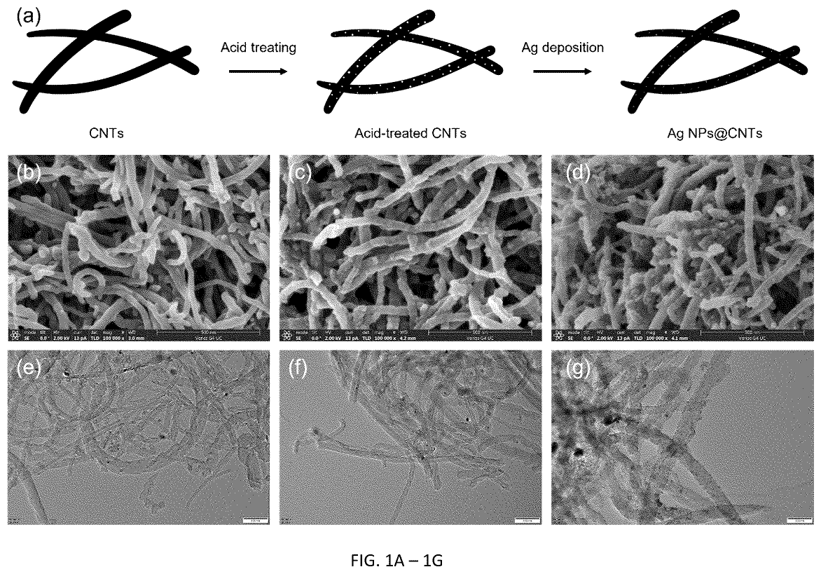

FIG. 1 illustrates the preparation process and morphological characteristics of the material. As shown in FIG. 1A, silver nanopowders (Ag NPs@CNTs) modified on acid-treated carbon matrices were synthesized by a two-step method. Carbon nanotubes were acid-treated to increase the surface active site, and then silver nanoparticles were deposited on the surface of the acid-treated carbon nanotubes by redox reactions to form silver nanopowders on acid-treated carbon matrices (silver nanoparticles @ carbon nanotubes or Ag NPs@CNTs), and the chemical changes that occur in this process could be expressed by the following chemical equation: Sn²⁺2Ag=Sn⁴⁺2Ag). Carbon nanotubes, with an average diameter of about 50 nm and a length of about 10 μm, were purchased from XFNANO. The surface of the acid-treated carbon nanotubes was rough with many small bumps and defects acting as active sites that favored the deposition of silver (See the field emission scanning electron microscopy (FESEM) image of FIG. 1B and the scanning electron microscopy (TEM) image of FIG. 1E). After the deposition of silver nanoparticles, the original structure of the nanotubes was maintained, and the size of the silver nanoparticles on the surface was about 5 nm, and the distribution was uniform (See DFESEM and GTEM of FIG. 1).

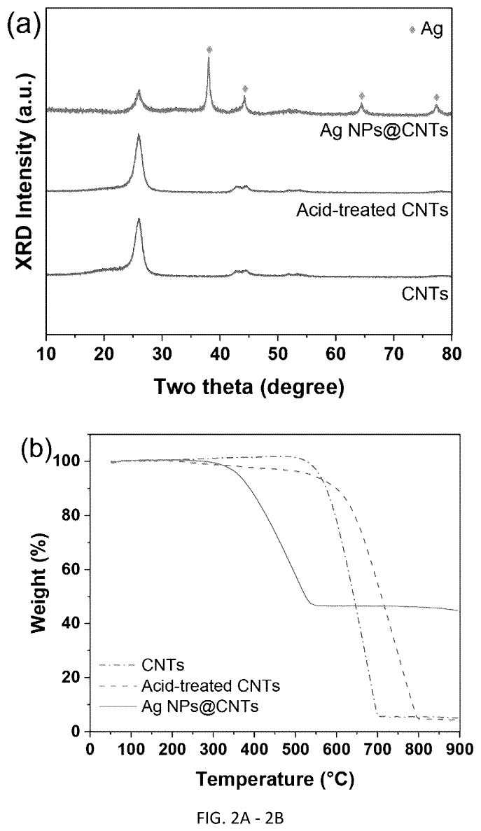

FIG. 2 illustrates the X-ray diffraction (XRD) diagram of the material, and as shown in FIG. 2A, the phase structure of the silver nanoparticle@carbon nanotube (Ag NPs@CNTs) powder was metallic silver phase (PDF #87-0717), as well as the phase structure of carbon nanotubes (PDF #75-1621). The results of thermogravimetric analysis showed that the weight ratio of silver nanoparticles in Ag NPs@CNTs was about 40 wt. %, as shown in FIG. 2B.

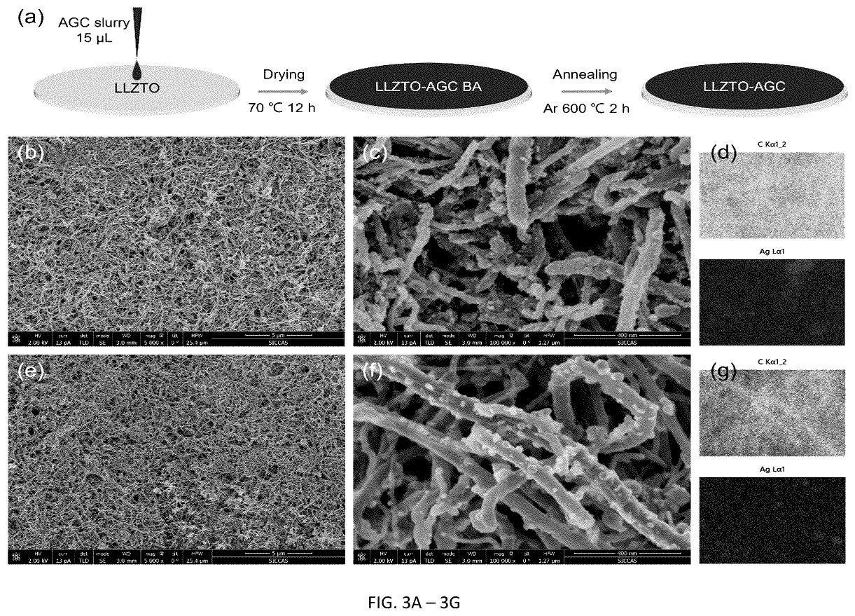

FIG. 3 shows the preparation process and morphological characteristics of LLZTO-AGC BA and LLZTO-AGC. Silver nanoparticles@carbon nanotube-modified LLZTO (LLZTO-AGC) was prepared by the pulping technique (FIG. 3A). A slurry of 15 μL of silver nanoparticles@carbon nanotubes (AGCs) was dropped onto the polished surface of LLZTO and dried to form silver nanoparticle@carbon nanotube-modified LLZTO (LLZTO-AGC BA, FIG. 3B), which was then annealed to obtain LLZTO-AGC. After annealing, a 3D network layer was formed on the surface of LLZTO-AGC with a porous structure and good uniformity over a large area (FIG. 3E). During annealing, the silver nanoparticles in the AGC layer that facilitated the wetting of molten Li grew from about 5 nm to about 50 nm (FIGS. 3C and 3F).

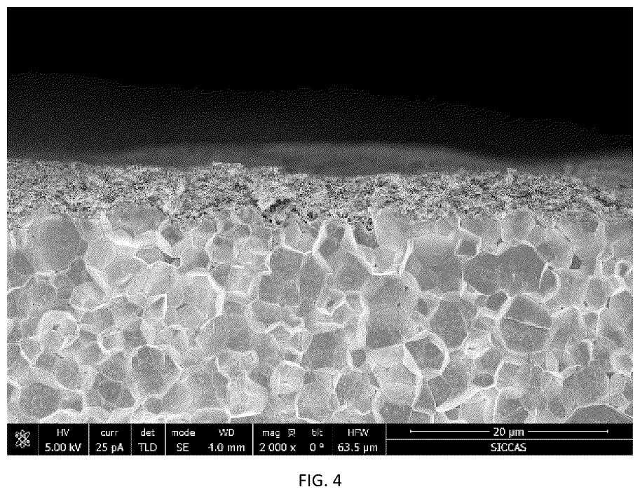

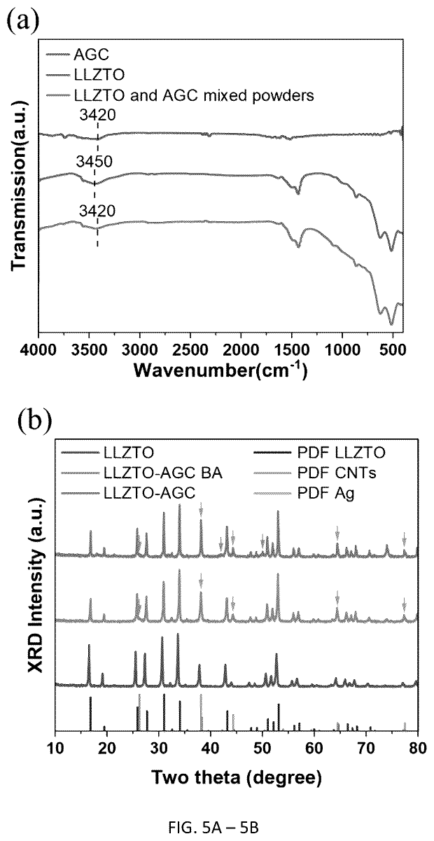

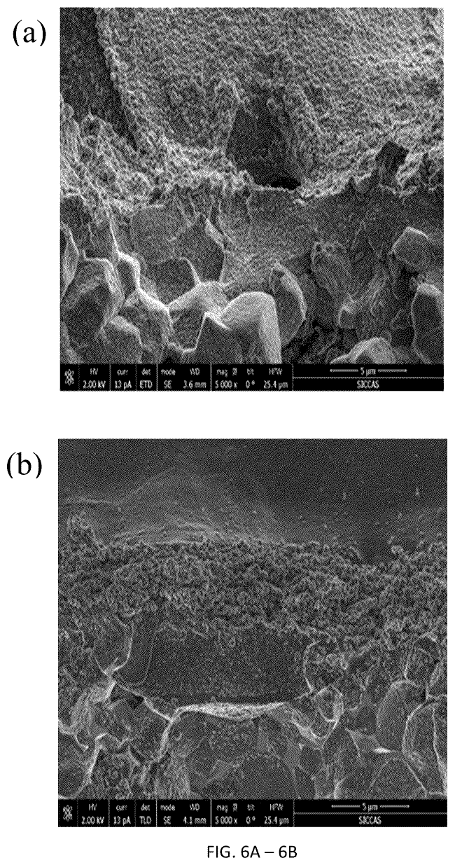

FIG. 4 illustrates the interface characteristics of LLZTO-AGC. The modified layer (AGC) had a vertical thickness of 4.3 microns and was in good contact with LLZTO, making the surface of LLZTO smooth by filling surface holes and voids. It was speculated that the acid-treated carbon nanotubes were bonded to LLZTO, which promoted the wettability of the carbon nanotube matrix to LLZTO, forming an ideal adhesive interface.

FIG. 5 illustrates the characterization of the material. The hydroxyl peaks of AGC and LLZTO in the Fourier Transform Infrared Spectroscopy (FTIR) spectra (FIG. 5A) were 3420 cm⁻¹ and 3450 cm⁻¹, respectively, and moved to 3420 cm⁻¹ in the spectrum of the LLZTO and AGC mixed powders, indicating the formation of hydrogen bonds between the hydroxyl groups. Due to the formation of hydrogen bonds between the acid-treated carbon nanotubes and LLZTO, the wettability of the carbon nanotube matrix to LLZTO was promoted, and an ideal adhesive interface was formed. The XRD pattern (FIG. 5C) showed that LLZTO maintained the cubic phase structure unchanged in LLZTO-AGC. The peaks of 26.2° corresponded to carbon nanotubes, and the peaks of 38.1°, 44.3°, 64.5° and 77.4° corresponded to silver.

FIG. 6 compares the interface behavior between Li/LLZTO and Li/LLZTO-AGC. The Li/LLZTO interface was constructed by molten lithium method. A piece of lithium foil was attached to the LLZTO and heated to 400° C. for 3 mins. For the original LLZTO (polished only), the FESEM graph showed that the lithium shrunk and formed folds after cooling (FIG. 6A, left) with a significant gap (micron scale) between the interfaces. In the case of LLZTO-AGC, the lithium diffused and appeared smooth after cooling (FIG. 6B, right) with no gaps or defects observed at the interface, demonstrating that Li was in close contact with LLZTO.

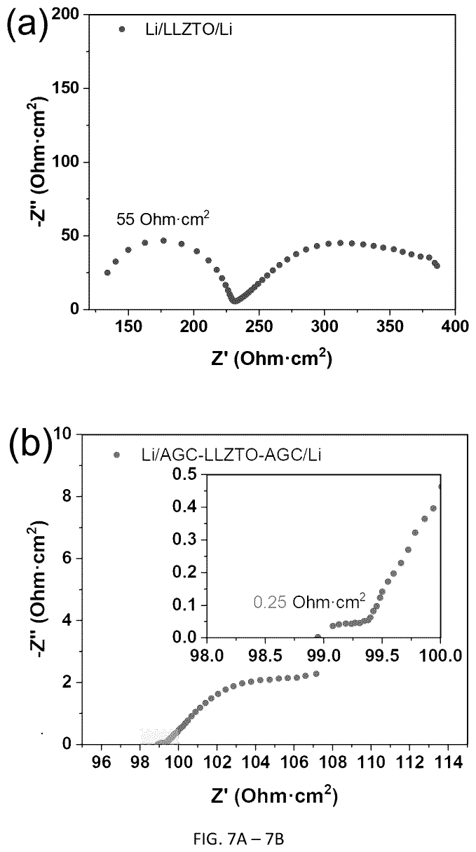

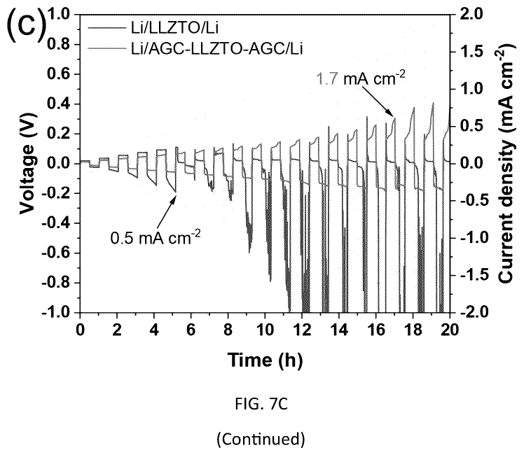

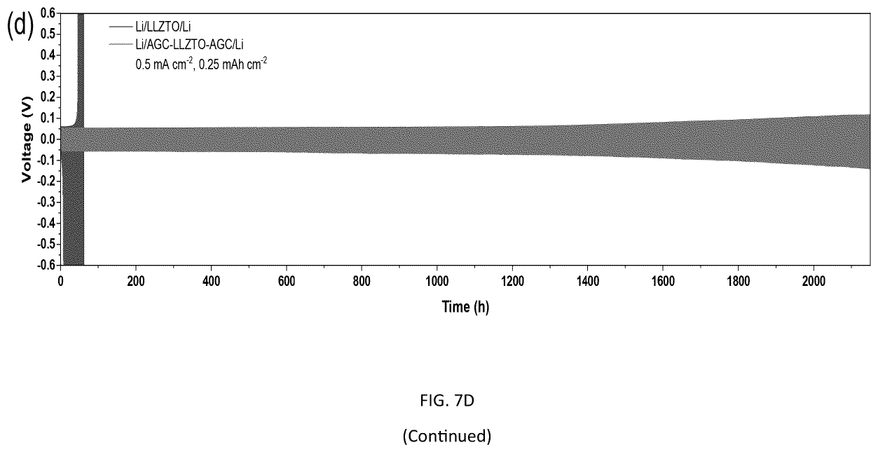

FIG. 7 shows the electrochemical performance of a Li-symmetrical cell at 25° C. In order to evaluate the electrochemical performance of the constructed Li/LLZTO-AGC interface, a Li/AGC-LLZTO-AGC/Li symmetrical cell was assembled. As a control, Li/LLZTO/Li cells were also prepared using the same method. The interface resistance decreased dramatically from 55 Ω cm² (Comparative Sample 1, FIG. 7A) to 0.25 Ω cm²(Sample 1, FIG. 7B), indicating that the Li/LLZTO-AGC interface was not only continuous on the physical surface of LLZTO but also electrochemically compact. As shown in FIG. 7C, the CCD of the cell was determined by performing a step current density test with a step current of 0.1 mA cm⁻² in the range of 0.1-2 mA cm⁻², and as the current density increased, the voltage response steadily increased without an abrupt voltage drop until the current density exceeded 1.8 mA cm⁻², indicating that the CCD of the Li/AGC-LLZTO-AGC/Li cell was 1.7 mA cm⁻²(sample 1). The CCD was significantly improved compared to 0.5 mA cm⁻² of the unmodified LLZTO (Comparative Sample 1). To demonstrate interfacial stability, a long cycle was performed on a symmetrical cell. FIG. 7D showed the corresponding electrochemical peel/plating curves for lithium at a current density of 0.5 mA cm⁻² and a cycle time of 30 minutes. The Li/AGC-LLZTO-AGC/Li battery had a stable cycle of 2155 hours, and the voltage polarization was small and stable, indicating that the Li/LLZTO-AGC interface was highly stable. In contrast, Li/LLZTO/Li battery showed severe polarization.

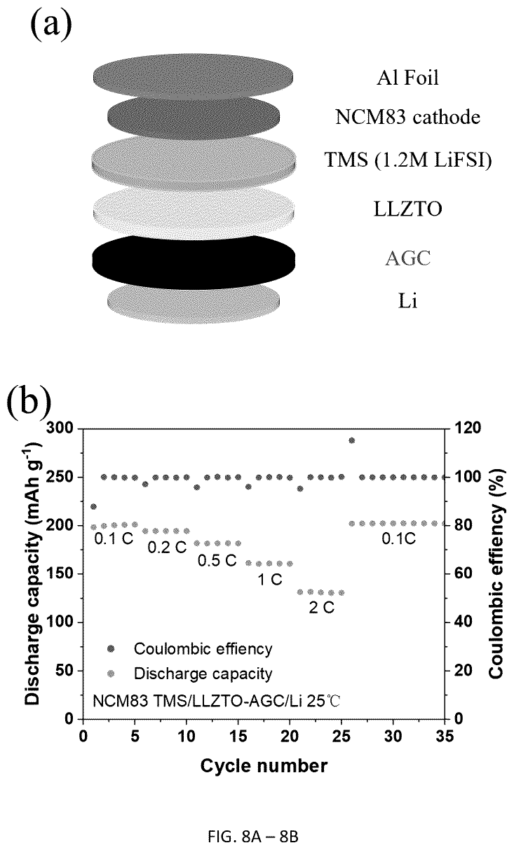

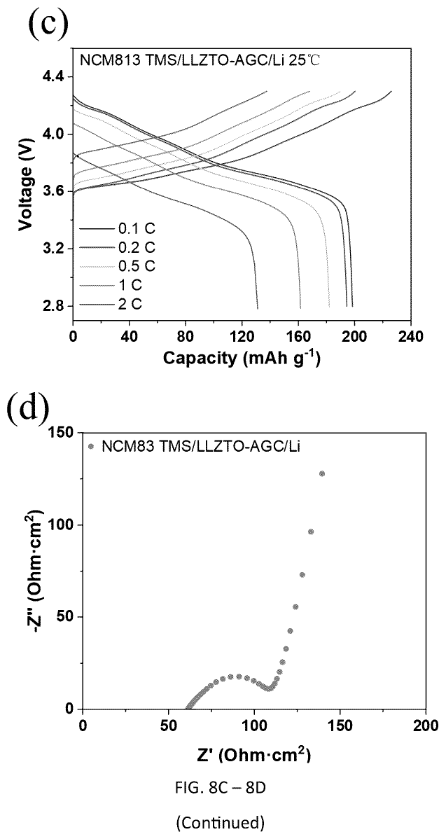

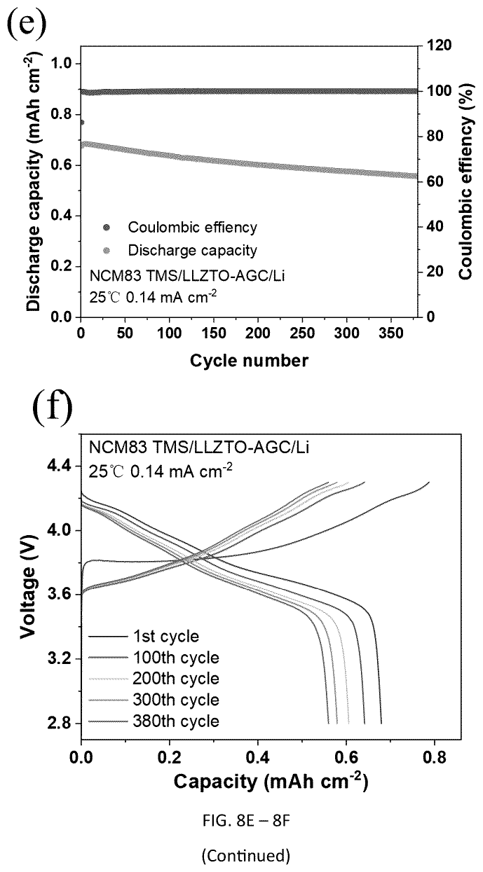

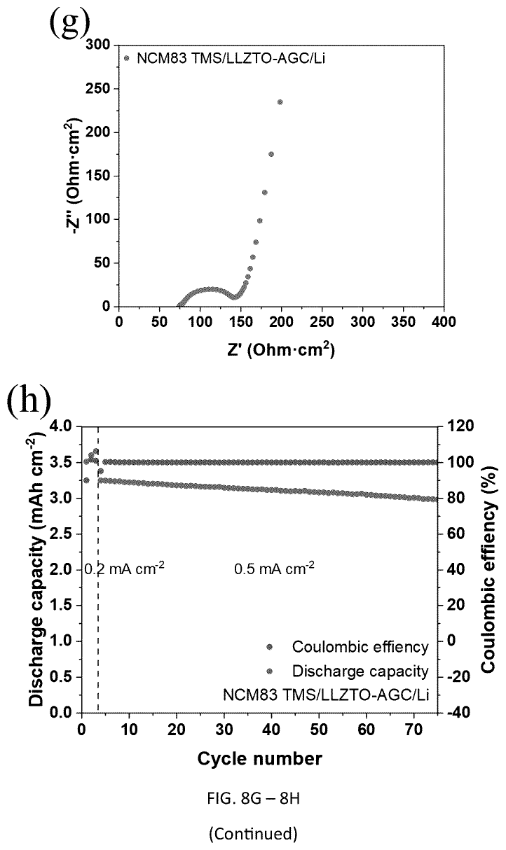

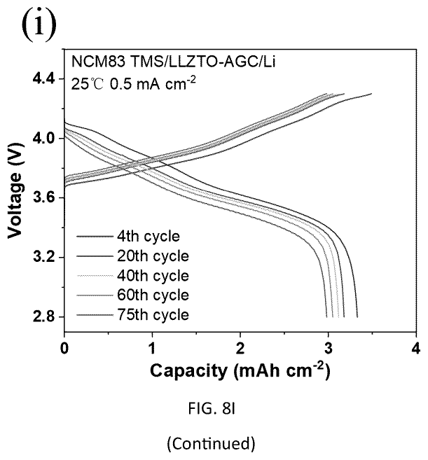

FIG. 8 shows the electrochemical performance of a quasi-solid-state full cell (Sample 2 and Sample 3). FIG. 8A illustrates the structure of the battery. As shown in FIGS. 8B and 8C, the rate performance of the battery was carried out at rates of 0.1, 0.2, 0.5, 1, 2, and 0.1 C, with discharge capacities of 198, 194, 182, 162, 131, and 202 mAh g−1, respectively. When discharged at a high rate of 2C, the discharge capacity was 66% of the 0.1 C rate. The low-load NCM83 TMS/LLZTO-AGC/Li full cell had a resistance of 120 (2 cm²(FIG. 8D) and an initial discharge capacity of 0.68 mAh cm⁻². The battery retained a discharge capacity of 0.56 mAh cm⁻² after 380 cycles at 0.14 mA cm⁻², with a capacity retention rate of 82% (FIGS. 8E and 8F). The high-load NCM83 TMS/LLZTO-AGC/Li full cell had a resistance of 150 £2 cm²(FIG. 8G) and an initial discharge capacity (4th cycle) of 3.33 mAh cm⁻². At 0.5 mA cm⁻², the battery could maintain a capacity of 2.98 mAh cm⁻² after 75 cycles, with a capacity retention rate of 92% (FIGS. 8H and 8I), indicating that the AGC layer with three-dimensional structure and porosity could alleviate the Li/SSE interface damage during cycling and allow for large-capacity lithium deposition/peel, which could match the high-load cathode and obtain good cycling performance of quasi-solid-state batteries.

The advantages of the present invention include: (1) Low interface resistance: the modified layer realizes close contact with the solid electrolyte (SSE) and the lithium anode, so that the ideal solid-solid contact characteristics are exhibited at the interface, and the resistance is only 0.25 Ω cm². (2) Higher critical current density: the modified layer successfully inhibits the formation of lithium dendrites, and can guide the lithium plating and peeling process to be more uniform, with a critical current density of up to 1.7 mA cm⁻². (3) Higher interfacial stability: the existence of the modified layer helps to alleviate the interfacial problem and significantly prolongs the cycle life of the battery, which lasts for 2155 hours at a current density of 0.5 mA cm⁻². (4) Highly loaded cathode: the modified layer with a three-dimensional (3D) structure and porosity mitigates the damage to the lithium/solid electrolyte (SSE) interface during cycling and enables large-capacity lithium plating/peeling; and this property allows the material to be matched to high-load cathodes and imparts excellent cycling performance to solid-state batteries.

As used herein, the terms “approximately”, “about”, “substantially” and similar terms are intended to have broad meanings consistent with the common and accepted usage of those skilled in the field covered by the subject matter of this disclosure. Those skilled in the art and those skilled examining the invention should understand that these terms are intended to allow the description of certain features described and claimed without limiting the scope of those features to the precise numbers provided. Accordingly, these terms should be construed to indicate that an impractical or insignificant modification or alteration of the described and claimed subject matter is considered to be within the scope of the invention as described in the attached claims.

As used herein, the terms “particle” and “powder” have the same meaning in substance and can be used interchangeably without affecting the understanding and implementation of the technical content of the present invention. In describing the present invention, the expressions “particles” or “powders” are used to refer to the same type of solid substance, i.e., solid particles with dimensions in the range of microns to millimeters. These particles can have various shapes like spherical, cube, cylinder, polyhedron, etc., or they can be a mixture of many shapes.

Published specific and preferred values for composition, component, additives, size, conditions, time and similar aspects and their range are for illustrative purposes only, including values with other definition or other values within the defined range. The compositions, articles and methods disclosed herein may include any value described herein or any combination of values, specific values, more specific values and preferred values, including explicit or implied intermediate values and ranges.

For the use of substantially any plural and/or singular term in the art, a person skilled in the art may translate it from plural to singular and/or from singular to plural, depending on the context and/or application. For the sake of clarity, the various singular/plural permutations can be clearly spelled out here.

It is obvious to those skilled in the art that some non-essential improvements and adjustments made according to the above contents of the present invention belong to the scope of protection of the present invention. Therefore, the subject matter of the claimed protection is not limited except according to the attached claims and their equivalents.

What is claimed:

1. A solid electrolyte with a modified layer comprises: a solid electrolyte and a modified layer coated on the solid electrolyte, wherein the solid electrolyte and the modified layer are connected by hydrogen bonds, wherein the modified layer comprises an acid-treated carbon matrix and silver nanoparticles modified thereon.

2. The solid electrolyte with a modified layer according to claim 1, wherein the thickness of the modified layer is in the range of 0.2-10 nm.

3. The solid electrolyte with a modified layer according to claim 1, wherein the particle size of the silver nanoparticles is in the range of 2-20 nm.

4. The solid electrolyte with a modified layer according to claim 1, wherein the weight ratio of silver nanoparticles in the modified layer is in the range of 30% to 50%.

5. The solid electrolyte with a modified layer according to claim 1, wherein the carbon matrix comprises: carbon nanotubes (CNTs), carbon nanofibers (CNFs), graphene oxide (GO), three-dimensional (3D) carbon or a combination thereof.

6. The solid electrolyte with a modified layer of claim 1, wherein the carbon matrix is a carbon nanotube with an aspect ratio in the range of 100 to 300.

7. The solid electrolyte with a modified layer according to claim 1, wherein the porosity of the modified layer is in the range of 20% to 60%.

8. The solid electrolyte with a modified layer according to claim 1, wherein the solid electrolyte comprises: Li₇La₃Zr₂O₁₂(LLZO), tantalum-doped garnet electrolyte (LLZTO), Li₁₀GeP₂S₁₂, Li_{1.5}Al_{0.5}Ge_{1.5} (PO₄)₃, Li_{1.4}Al_{0.4}Ti_{1.6}(PO₄)₃, Li_{0.55}La_{0.35}TiO₃ or a combination thereof.

9. A lithium battery comprises: a positive electrode, an electrolyte on the positive electrode, and a lithium negative electrode on the electrolyte, wherein the electrolyte is a solid electrolyte with a modified layer, comprising: a solid electrolyte and a modified layer coated on the solid electrolyte, wherein the solid electrolyte and the modified layer are connected by hydrogen bonds, wherein the modified layer comprises an acid-treated carbon matrix and silver nanoparticles modified thereon.

10. The lithium battery of claim 9, wherein the thickness of the modified layer is in the range of 0.2-10 nm.

11. The lithium battery of claim 9, wherein the particle size of the silver nanoparticles is in the range of 2-80 nm.

12. The lithium battery of claim 9, wherein the weight ratio of silver nanoparticles in the modified layer is in the range of 30% to 50%.

13. The lithium battery of claim 9, wherein the carbon matrix comprises: carbon nanotubes (CNTs), carbon nanofibers (CNFs), graphene oxide (GO), three-dimensional (3D) carbon or a combination thereof.

14. The lithium battery of claim 9, wherein the carbon matrix is a carbon nanotube, and its aspect ratio is in the range of 100 to 300.

15. The lithium battery of claim 9, wherein the porosity of the modified layer is in the range of 20% to 60%.

16. The lithium battery of claim 9, wherein the solid electrolyte comprises: Li₇La₃Zr₂O₁₂ (LLZO), tantalum-doped garnet electrolyte (LLZTO), Li₁₀GeP₂S₁₂, Li_{1.5}Al_{0.5}Ge_{1.5}(PO₄)₃, Li_{1.4}Al_{0.4}Ti_{1.6}(PO₄)₃, Li_{0.55}La_{0.35}TiO₃ or a combination thereof.

17. A method for preparing a solid electrolyte with a modified layer comprises: treating a carbon matrix with an acid, modifying silver nanoparticles on the acid-treated carbon matrix to obtain the silver nanoparticles modified on the acid-treated carbon matrix (Ag NPs@CNTs), mixing the Ag NPs@CNTs in suspension and coating them on a solid electrolyte, and drying and annealing the solid electrolyte to obtain the solid electrolyte with a modified layer.

18. The method of claim 17, wherein the weight percentage of Ag NPs@CNTs in suspension is in the range of 2% to 6%.

19. The method of claim 17, further comprising that after treating a carbon matrix with an acid, the acid-treated carbon matrix is sensitized with a tin ion solution.
